(19) United States
(12) Patent Application Publication
(10) Pub. No.: US 2014/0313547 A1
(43) Pub. Date: Oct. 23, 2014

(54) DEVICE HAVING AN INK ZONE OPERATING PANEL WITH A TOUCH SCREEN FOR OPERATING PRINTING SUBSTRATE PROCESSING MACHINES

(71) Applicant: HEIDELBERGER DRUCKMASCHINEN AG, HEIDELBERG (DE)

(72) Inventors: DIETER HAUCK, EBERBACH (DE); GILLES GONZALEZ, MOTHERN (FR); WINFRIED BERG, HEIDELBERG (DE); EDELBERG KOENIG, KRONAU (DE); ANDREAS WAGNER, GRABEN NEUDORF (DE); VOLKHARD FRANKE, SCHRIESHEIM (DE); THORSTEN METZ, EBERBACH (DE)

(73) Assignee: HEIDELBERGER DRUCKMASCHINEN AG, HEIDELBERG (DE)

(21) Appl. No.: 14/256,086

(22) Filed: Apr. 18, 2014

(30) Foreign Application Priority Data
Apr. 18, 2013 (DE) 102013006699.9

(51) Int. Cl. G06F 3/12

(52) U.S. Cl. CPC G06F 3/1253; G06F 3/1204
USPC 358/1.15

(57) ABSTRACT

A device for operating printing substrate processing machines includes a control panel having a deposition surface for receiving printing substrates and an operating element embodied as a touch screen for controlling the printing substrate processing machine by using a control computer. The touch screen is disposed at a front edge of the control panel in front of the deposition surface for receiving the printing substrate. The touch screen extends at least across the entire width of the deposition surface for receiving the printing substrate.

### CROSS-REFERENCE TO RELATED APPLICATION

This application claims the priority, under 35 U.S.C. §119, of German Patent Application DE 10 2013 006 699.9, filed Apr. 18, 2013; the prior application is herewith incorporated by reference in its entirety.

### BACKGROUND OF THE INVENTION

### Field of the Invention

The present invention relates to a device for operating printing substrate processing machines. The device includes a control console having a deposition surface for receiving printing substrates and an operating element embodied as a touch screen for controlling the sheet processing machine by using a control computer. The touch screen is disposed on the front edge of the control console in front of the deposition surface for receiving the printing substrate.

Such devices for operating a machine for processing printing substrates are known from German Patent Application DE 101 20 487 A1. That document discloses a control console for a multicolor printing press. The control console includes a touch screen for operating the printing press in its front region in front of a deposition plate for receiving printing substrates. The touch screen is displaceable across the width. A menu for adjusting and recognizing ink zones in the printing press may be selected on the touch screen. In the menu, the ink zones are displayable in a line in a bar-code-like way or in the form of digital values. The touch screen display is thus movably positioned along the width of the printing substrate. In the process, the position of the display relative to the printing substrate is detected and the ink zones corresponding to the position are displayed as a function of the detected position. That is intended to simplify the operation of the ink zones.

German Patent Application DE 10 2004 010 484 A1 discloses a device for displaying and/or controlling ink zone settings in printing presses wherein the colors on the display are adapted to the printing ink that is being used. The display and operating elements are likewise located in the front region of the control console of a printing press, yet the display and operating elements extend across the entire width of the deposition surface for a printing substrate. The display is formed of light-emitting diodes (LEDs) in the three basic colors red, green, and blue, which may display any desired color if suitably actuated. The LEDs are firmly correlated with corresponding ink zones across the entire width of the deposition table, each indicating the opening state of an ink zone.

A disadvantage of the known prior art is that the displaceable touch screen needs to be positioned in front of the ink zone to be operated before the operator may adjust the corresponding ink zones. The alternative known method using stationary diodes in the ink zones in front of the sheet deposition table is faster and simpler. Since there may be 32 or even 64 ink zones to be operated in large-format sheet-fed printing presses, having to move the touch screen to the correct location each time is cumbersome for the printing press operator. A disadvantage of the conventional device involving firmly allocated diodes is, however, that such a device only allows adjustment of the ink zone openings but not the initiation of other operating processes on the printing press. For that reason, the conventional device requires an additional touch screen, usually in a lateral region of the control console of the printing press, to control the important functions of the printing press.

### SUMMARY OF THE INVENTION

It is accordingly an object of the invention to provide a device having an ink zone operating panel with a touch screen for operating printing substrate processing machines, which overcomes the hereinafore-mentioned disadvantages of the heretofore-known devices of this general type, which simplifies the operation of printing presses and which dispenses with different operating elements.

With the foregoing and other objects in view there is provided, in accordance with the invention, a device for operating a printing substrate processing machine. The device comprises a control console including a deposition surface for receiving printing substrates and a front edge in front of the deposition surface, a control computer, and an operating element constructed as a touch screen configured to control the printing substrate processing machine using the control computer. The touch screen is disposed at the front edge of the control console and the touch screen extends at least across an entire width of the deposition surface.

Therefore, in accordance with the present invention, the control console for controlling a machine for processing printing substrates, in particular a printing press, includes a touch screen in the front region in front of a sheet-deposition surface for controlling printing substrates. The touch screen extends at least across the entire width of the deposition surface for receiving the printing substrate. As a result, operating and display elements may be displayed on the touch screen in such a way that the operator is able to directly associate the operating and display elements with all regions, in particular ink zones, of printing substrates resting on the deposition surface for inspection. In this respect, it is possible to display each ink zone on the touch screen precisely in the location that corresponds to the ink zone on the deposited printing substrate. Thus, as in prior art devices that include conventional diodes, for the operator, there is an immediate association of the operating elements for adjusting the ink zones as displayed on the screen. Yet additionally, the touch screen may be used to control further or all functions of the printing press, dispensing with the need for an additional touch screen for operating the printing press as in the prior art. Thus, further settings of the printing press relating to specific areas of a printing substrate such as the settings of the distribution of air in the sheet conveying path in sheet-fed printing presses, in particular settings of the distribution of air in the delivery or the adjustment of braking belts in the delivery, may easily be allocated and adjusted.

The touch screen, which is disposed across the entire width of the deposition surface, is thus not only used to adjust the ink zones but may also be used to adjust all functions of the printing press. This means that in contrast to the prior art, all operating functions are concentrated in one location of the control console rather than split up between a touch screen and conventional diodes or provided on a displaceable touch screen that makes operation cumbersome, in particular where large-format sheet-fed printing presses that have a large number of ink zones are concerned. For the first time, the present invention allows all functions that relate to specific areas of a printed sheet to be immediately correlated on a touch screen to those areas that are actually concerned on the sheet in a one-to-one relationship. Due to the free programmability of a touch screen, it is even possible to accommodate special functions such as the display of ink zone openings in the context of spot colors. The immediate correlation with the printing substrate results in a straightforward hand/eye coordination since the display and the input on the touch screen directly merge into one another. The input and display of the printing press is directly and quickly made in the front region of the control console and the operator does not have to divide his or her attention between different operating elements such as diodes for operating as ink zones and touch screens disposed on the side. The same advantages apply to other zonal adjustments, for example to inputting and modifying target values for color measurement devices, locking and releasing individual zones for color readjustments, displaying target value deviations for color measurement devices, displaying deviations for inspection systems, and positioning measurement devices, measurement strips, or reference marks.

In accordance with another feature of the invention, in order to be able to control the various functions of the printing press in a convenient way, a provision is advantageously made for the touch screen to have at least one additional user interface for controlling further functions of the printing press. In addition to the user interface for making zonal settings and adjustments, for example of ink keys in the printing press, the touch screen has at least one additional user interface for adjusting other functions of the printing press. Basically, there may be an additional user interface for every operational area of a printing press, allowing the operator convenient access to specific functional areas by selecting a suitable user interface. It is also possible for multiple user interfaces to be simultaneously displayable next to each other on the touch screen. Since the touch screen extends across the entire width of the deposition surface, a simultaneous display of multiple user interfaces next to each other is not difficult. Typical user interfaces of printing presses include user interfaces for processing a list of jobs, a user interface for setting up the machine, and a further user interface for servicing purposes. A configuration of multiple user interfaces next to each other even allows multiple operators to simultaneously operate the printing press through the touch screen. One operator may use one user interface to make one type of adjustment while another operator uses another user interface for other types of adjustments. Examples are: subdividing the ink zones into left-hand sheet half/right-hand sheet half, adjusting the ink/water balance in one section, or register adjustments in another section of the touch screen. Alternatively, only one user interface controlling multiple functions of the printing press may be provided; in some cases, a single user interface may be sufficient for all functions.

In accordance with a further feature of the invention, a provision is made for the touch screen to be composed of multiple screens. In this embodiment, preferably multiple 10-inch touch screens are placed next to each other, with eight ink zones displayable on one 10-inch screen. This means that for a sheet-fed printing press in the 52 format with 16 ink zones, two touch screens disposed next to each other are used. For a sheet-fed printing press in the 102 format with 32 ink zones, four touch screens are required. Such 10-inch touch screens are widely used today and are thus standard components available at a low price. Since eight ink zones may be displayed on one touch screen, it is possible to cover all format classes of sheet-fed printing presses with a single touch screen as a standard component. When such standardized touch screens are used, however, an important aspect is to select touch screens that have a minimum border in order to create the impression that the touch screens disposed next to each other form a single elongated screen. Another important aspect is to ensure that the ink zones are displayed on the touch screens in such a way that they correspond to the ink zones on the printing substrate deposited on the deposition surface.

In accordance with an added, alternative feature of the invention, the touch screen may be a single touch screen of elongated shape. Such narrow, elongated touch screens are custom-made and thus more expensive. The advantage of such an embodiment is that there are no disruptive seams between two touch screens, allowing a seamless display of operating elements across the entire width of the control console.

In accordance with an additional, alternative feature of the invention, a provision is made for the touch screen to be at least partly covered by the deposition surface. This embodiment allows the provision of a large-format standard touch screen, eliminating the disadvantages of the aforementioned embodiments. In order to give the operator the impression of a narrow touch screen of elongated shape, a large part of the touch screen is covered, for example by the deposition surface, leaving only part of the touch screen visible to the operator. Of course, in this case an important aspect is that when the touch screen is controlled by the control computer, all information is displayed only in the non-covered area of the touch screen and no operating and display elements are covered by the deposition surface.

In accordance with yet another advantageous feature of the invention, the control console may have a rear wall carrying a large-format screen and this large-format screen may be controllable using the touch screen. In this embodiment, a large-format screen, also known as a wall screen, which is not a touch screen and is only used to display information and operating elements, is disposed on the rear wall. Actual operations, however, are made on the elongated touch screen disposed in the front region of the control console. Since the large screen likewise extends across the entire width of the deposition surface, there may likewise be a one-to-one correlation between operating elements on the touch screen on the front side of the control console and the display elements on the large screen on the rear wall. A great advantage of this feature for the operator is that an immediate association between the operating elements in the front region of the control console, the printing substrate, and the display on the large screen on the rear wall of the control console is possible. The operator thus has the large screen, the deposited printing substrate, and the operating elements on the touch screen in the front region of the control console directly in view and does not have to make associations between the three regions.

In accordance with yet a further feature of the invention, a provision is made for the device for operating the machine for processing printing substrates to be equipped with a measurement device for measuring printing substrates and that the measurement device is controllable using the touch screen. Measurement devices of this kind, in particular color measurement devices, are used to examine the quality of the print by optically scanning printing substrates deposited on the deposition surface, for example, or conveyed through the printing press. In accordance with the present invention, a provision is made for a dedicated user interface to be provided to control this measurement device. This user interface may likewise be operated by using the touch screen in the front region of the control console. In this way, the touch screen conveniently allows target values for the color measurement device to be input and modified, deviations from the target value to be displayed, and even deviations detected by inspection systems to be displayed. The color measurement device on the deposition surface may easily be positioned relative to color measurement strips or reference marks through the touch screen since in this context, too, an immediate association between the position of the color measurement device above the printing substrate deposited on the deposition surface and the operating elements on the touch screen in front of the deposition surface is possible.

In accordance with a concomitant, particularly advantageous feature of the invention, a provision is made for the control console to have a detection device for detecting when an operator's body parts touch or cover the touch screen and for preventing unintentional operation of the touch screen. Such a detection device may be disposed in the upper region of the control console, for example, and may scan the region of the touch screen. This may be achieved by a camera suitable to detect an operator bent over the touch screen and deposition surface and a corresponding evaluation of the recorded pictures. Alternatively, an optical curtain similar to a photosensor may be provided to detect an operator bent over the touch screen and may additionally be evaluated by using a camera. The optical curtain may be formed by a row of LEDs. Alternatively, the optical curtain may be created by outputting a defined pattern on the touch screen. This defined pattern may then be easily evaluated by the camera in the upper region of the control console. If infrared LEDs are used in the process or if the defined pattern is displayed for a short period (less than 300 milliseconds) only, this function is invisible and does not bother the operator. Furthermore, it is possible for the optical curtain to be the normal display of the touch screen. In this case, the camera disposed above the touch screen evaluates whether the display on the touch screen is visible or whether large areas or parts are covered. The optical curtain may be only a specific area such as a status indicator region displayed in specific areas of the touch screen. In this embodiment, the camera evaluation needs to ensure that the display and the camera are synchronized.

Other features which are considered as characteristic for the invention are set forth in the appended claims.

Although the invention is illustrated and described herein as embodied in a device having an ink zone operating panel with a touch screen for operating printing substrate processing machines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a control console according to the invention, including an elongated touch screen for operating a printing press, in which the touch screen is disposed in a front region of the control console;

FIG. 2 is a perspective view of a control console in which the touch screen is formed of a large standard touch screen and is partly covered by a deposition surface of the control console;

FIG. 3 is a plan view showing multiple user interfaces displayed in parallel on the touch screen; and

FIG. 4 is a plan view showing a touch screen composed of multiple touch screens disposed adjacent each other.

### DETAILED DESCRIPTION OF THE INVENTION

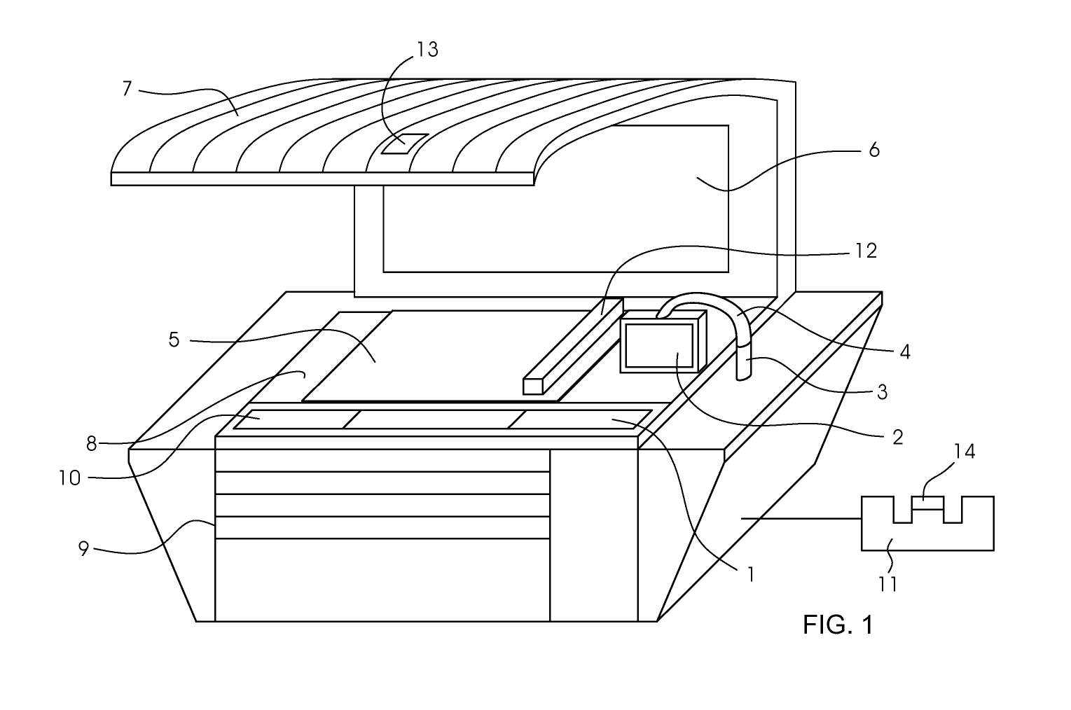

Referring now to the figures of the drawings in detail and first, particularly, to FIG. 1 thereof, there is seen a control console of a printing press 11. The control console is used to operate and control the printing press 11, i.e. to make the required adjustments. The control console is constructed to include a sheet deposition surface or table 8 on which printing substrates 5 coming from the printing press 11 may be deposited. In most cases, these printing substrates 11 will be sample sheets taken out of the printing press 11 for quality control purposes. An operator of the printing press 11 may carry out this quality control visually by comparing the printing substrate 5 to an original that is displayed on a large screen 6 on the rear wall of the control console. Similar to an exclusively visual comparison, it is also possible to use a color measurement device 12 to measure the printed sheet 5 and to compare the measured values to the original in an automated way. The control console further includes a roof 7 for screening the sheet deposition table 8 from light from above. In addition, it is possible to provide a color examination lamp on the roof 7 for illuminating the printing substrate 5 resting on the sheet deposition table 8 with standard light. A control computer 9, in most cases substantially formed of an industrial personal computer, is disposed in a housing underneath the sheet deposition table 8. The control computer 9 controls the printing press 11 and forwards all operational inputs made by the operator to the control of the printing press 11.

A touch screen 1 having an elongated shape is disposed in a front region of the control console in front of the sheet deposition table 8. This touch screen 1 may be used to operate most functions of the printing press 11. For this purpose, the touch screen 1 has multiple user interfaces 10 for setting various functions of the printing press 11. In particular, the user interfaces 10 include adjustment and display elements for setting ink zone openings in the printing press 11. The ink zones 14 extend across the entire width of the printing press 11 and are used for individually adjusting the amount of ink that is applied in the printing press region by region for every ink zone. Thus, the ink zones 14 are mirrored on the printing substrate 5, with the operating and adjustment elements displayed on one of the user interfaces 10 of the touch screen 1 in such a way that the respective operating element on the touch screen 1 is correlated with the respective ink zone on the printing substrate 5. In this manner, there is an immediate correlation between the displayed operating and adjustment elements on the touch screen 1 and the ink zone to be adjusted on the printing substrate 5.

In the embodiment of FIG. 1, there is an additional pivotable touch screen 2 attached to a pivot arm 3 by a mount 4. This pivotable touch screen 2 may likewise be used to control the functions of the printing press 11. However, there is no immediate correlation between the display/operating elements on the pivotable touch screen 2 and the effects on the printing substrate 5. Thus, in accordance with the invention, this further, pivotable touch screen 2 may be dispensed with. Furthermore, a detection device in the form of a camera 13 monitoring the touch screen 1 is attached to the roof 7. The camera 13 may detect, for example, when the operator bends over the touch screen 1, triggering or making unintentional operations on the screen. If such unintentional operations occur, the control computer 9 will block the forwarding of such unintentional user inputs to the printing press 11, avoiding erroneous operations.

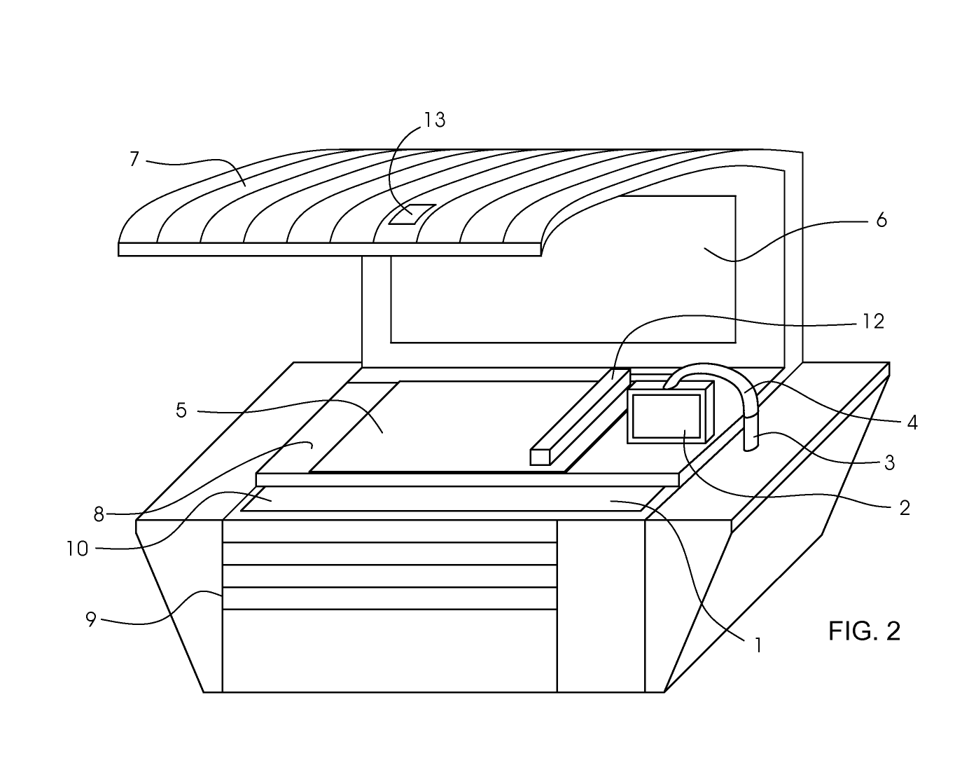

FIG. 2 illustrates a further embodiment of the present invention wherein the touch screen 1 is not constructed as an elongated screen. In this embodiment, a large rectangular touch screen 1 is provided. The largest part of the touch screen 1 is covered by the sheet deposition table 8 and only a small part in the front region in front of the sheet deposition table 8 is visible. This small area of the touch screen 1 mostly corresponds to the display and operating elements of the elongated touch screen 1 shown in FIG. 1. The control computer 9 is programmed to display operating and display elements only in the non-covered narrow strip of the touch screen 1 that is in front of the sheet deposition table 8.

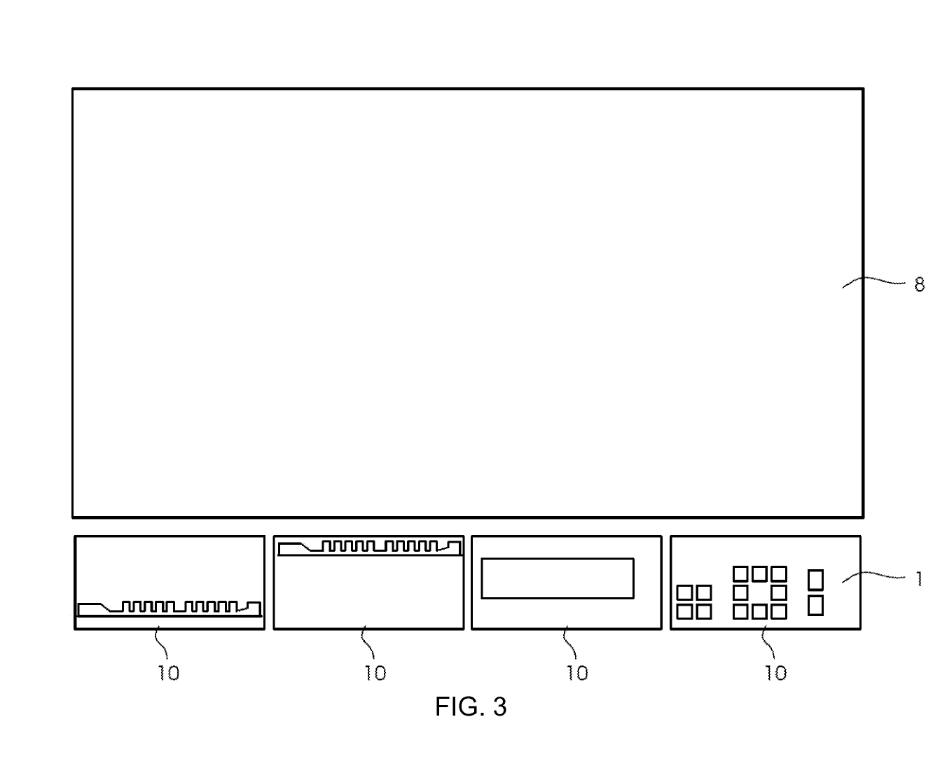

FIG. 3 illustrates multiple user interfaces 10 disposed next to each other for controlling various components of the printing press 11. These user interfaces 10 may be displayed next to each other on the touch screen of FIG. 1 or of FIG. 2. In this way it is possible for one or more operators to simultaneously adjust different functions of a printing press 11.

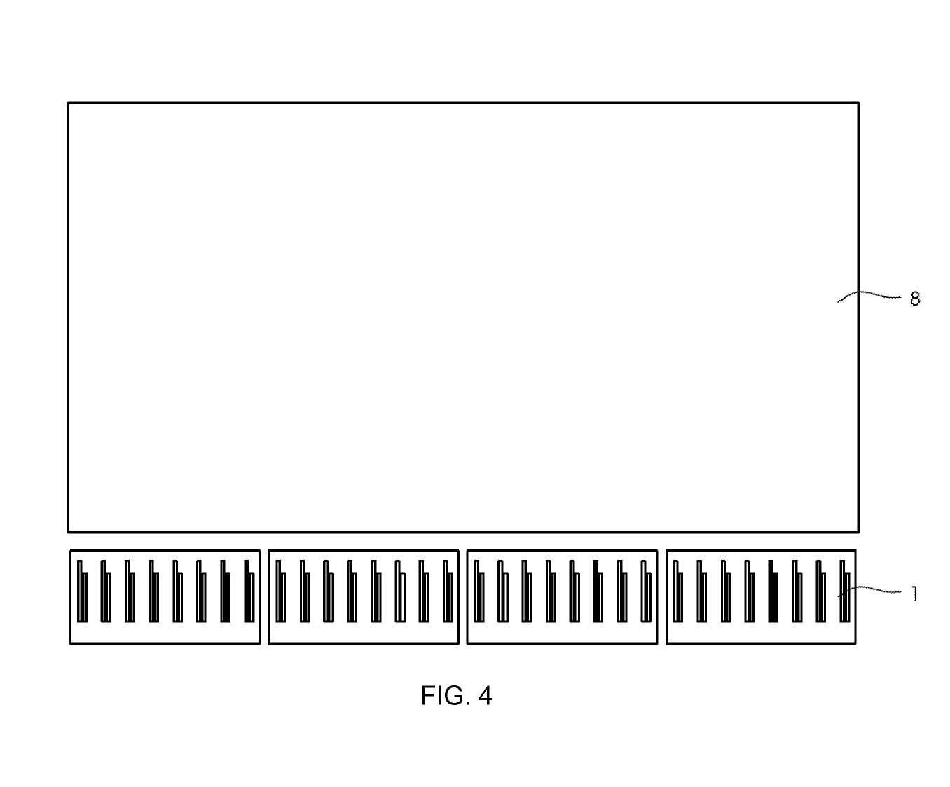

FIG. 4 illustrates a variation of the embodiment of FIG. 1 wherein the touch screen 1 is formed of four touch screens of similar construction. Each of these touch screens is embodied as a 10-inch display. Placed seamlessly next to each other, these touch screens form an elongated touch screen 1 as shown in FIG. 1. Each touch screen displays and controls eight ink zones, allowing a total of 32 ink zones to be set on the four touch screens. This is sufficient for a 102-format printing press.

1. A device for operating a printing substrate processing machine, the device comprising:
a control console including a deposition surface for receiving printing substrates and a front edge in front of said deposition surface;
a control computer; and
an operating element constructed as a touch screen configured to control the printing substrate processing machine using said control computer, said touch screen disposed at said front edge of said control console, and said touch screen extending at least across an entire width of said deposition surface.

2. The device according to claim 1, wherein the printing substrate processing machine is a printing press, and said touch screen includes a user interface for zonal adjustment in the printing press.

3. The device according to claim 1, wherein the printing substrate processing machine is a printing press, and said touch screen includes a user interface for zonal adjustment of ink zones in the printing press.

4. The device according to claim 2, wherein said touch screen includes at least one additional user interface for operating other functions of the printing press.

5. The device according to claim 3, wherein said touch screen includes at least one additional user interface for operating other functions of the printing press.

6. The device according to claim 1, which further comprises a measurement device configured to measure printing substrates, said measurement device being configured to be controlled by said touch screen.

7. The device according to claim 1, wherein said touch screen is composed of multiple screens.

8. The device according to claim 1, wherein said touch screen is a single screen having an elongated shape.

9. The device according to claim 1, wherein said touch screen is at least partly covered by said deposition surface.

10. The device according to claim 1, wherein said touch screen is configured to simultaneously display multiple user interfaces.

11. The device according to claim 1, wherein said control console has a rear wall, another screen being larger than said touch screen is carried on said rear wall, and said other screen is configured to be controlled by using said touch screen.

12. The device according to claim 1, wherein said control console includes a detection device configured to detect when body parts of an operator touch or cover said touch screen and to prevent an unintentional operation of said touch screen.
